(19) United States
(12) Patent Application Publication
(10) Pub. No.: US 2003/0004933 A1
(43) Pub. Date: Jan. 2, 2003

(54) Compound request processing

(76) Inventor: Doron Ben-Yehezkel, Newport Beach, CA (US)

Correspondence Address: J.D. Harriman II, COUDERT BROTHERS, 333 South Hope Street, 23rd Floor, Los Angeles, CA, 90071, US

(21) Appl. No.: 09/895,134

(22) Filed: Jun. 28, 2001

(51) Int. Cl. G06F 7/00

(52) U.S. Cl. 707/3

(57) ABSTRACT

The present invention provides a method and apparatus for compound request processing. In one embodiment, a server maintains a cache of data items it has provided to a client. When the client requests a data item from the server, the server retrieves the data item and also retrieves all available associated data items. The server determines which associated data items are unchanged. Then, the server transmits the data item along with information indicating whether associated data items are unchanged. In one embodiment, when a client wishes to request an associated data item, it first determines whether the server indicated that the associated data item is unchanged. If the associated data item is unchanged, the client uses the copy of the associated data item in the client's cache. If the associated data item is changed, the client requests the associated data item from the server.

### BACKGROUND OF THE INVENTION

1. Field of the Invention

The present invention relates to the field of client/server systems, and in particular to a method and apparatus for compound request processing.

2. Background Art

In some client/server systems, a client retrieves data from a server. Some data, web pages for instance, is associated with other data which the client will likely wish to retrieve as well. Typically, a client must issue several requests to a server to retrieve all associated data, and each request has an associated latency period. In some systems (e.g., wireless networks), the latency period is large. If the number of requests is large, the delay in retrieving all data becomes unacceptably large. Additionally, some data is retrieved on multiple occasions, which reduces the efficiency of the data transfer. In systems where data transfers between a client and a server are expensive (e.g., wireless networks for cell phones or pagers), sending the same data multiple times increases costs. These problems can be better understood by a review of client/server systems.

Client/Server Systems

In client/server systems, a client sends requests for service to a server. The server receives the requests of many clients and services these requests. In some systems, the request is for a data item. Some data objects are associated with other data objects which the client will likely wish to retrieve as well. For example, a web page may be associated with multiple images, frames or sound.

In prior art methods, a web page is requested by the client. The server retrieves the web page and sends it to the client. Then, the client requests the objects associated with the web page. The number of objects a client can retrieve simultaneously is four. If a web page contains 40 objects, the client must make requests at least 11 times (one time for the web page and ten times for the 40 objects).

FIG. 1 illustrates a prior art method of retrieving a web page and associated data items. At step 100, the client requests the web page from the server. At step 110, the server retrieves the web page. At step 120, the server transmits the web page to the client. At step 130, it is determined whether there are any associated data objects left to retrieve. If there are no associated data objects left to retrieve, at step 140, the retrieval is complete. If there is an associated data object left to retrieve, at step 150, the client simultaneously requests a maximum of four associated data objects from the server. At step 160, the server retrieves the requested data objects. At step 170, the server transmits the requested data objects to the client and the process repeats at step 130.

Each request between a client and a server is associated with a latency period. In some wireless networks (e.g., the client is a cellular phone or pager), the latency period is large because the transmission medium is unstable and is shared by many users. Thus, a high number of requests causes a large gap between when a web page is requested and when the web page and all associated data items are displayed.

Sometimes, some of the data items associated with a data item are altered. For example, a web page may contain an image or text that changes periodically. An image may be an advertisement which changes if another advertiser pays for the space. Similarly, a page may contain news headlines which change as new events occur. Thus, a client may refresh the web page by requesting it from the server again. However, some or all of page may be unchanged. In prior art methods, the client makes multiple requests to retrieve the page and all associated objects even though no object has changed. If bandwidth is expensive (e.g., wireless networks), the unchanged objects are retrieved at a high cost.

In a prior art method described in U.S. Pat. No. 6,115,384 entitled “Gateway architecture for data communication bandwidth-constrained and charge-by-use networks”, herein incorporated by reference, the cost associated with transmitting data over a section of a network where bandwidth is expensive is reduced by converting the data from TCP to a more efficient protocol before transmission over the bandwidth-constrained portion of the network and converting back to TCP after transmission.

### SUMMARY OF THE INVENTION

The present invention provides a method and apparatus for compound request processing. In one embodiment of the present invention, a server maintains a cache of data items it has provided to a client. When the client requests a data item from the server, the server retrieves the data item and also retrieves all available associated data items. The server determines which associated data items are unchanged. Then, the server transmits the data item along with information indicating whether associated data items are unchanged.

In one embodiment, when a client wishes to request an associated data item, it first determines whether the server indicated that the associated data item is unchanged. If the associated data item is unchanged, the client uses the copy of the associated data item in the client's cache. If the associated data item is changed, the client requests the associated data item from the server. In one embodiment, the client can request an unlimited number of associated data items from the server with one request. The server retrieves the associated data items and stores them in a cache. Then, the server transmits as many data items to the client as the client requests.

In another embodiment, the connection between the client and the server is a wireless network, and data items are web pages and associated objects.

### BRIEF DESCRIPTION OF THE DRAWINGS

These and other features, aspects and advantages of the present invention will become better understood with regard to the following description, appended claims and accompanying drawings where:

FIG. 1 is a flow diagram of a prior art method of retrieving a web page and associated data items.

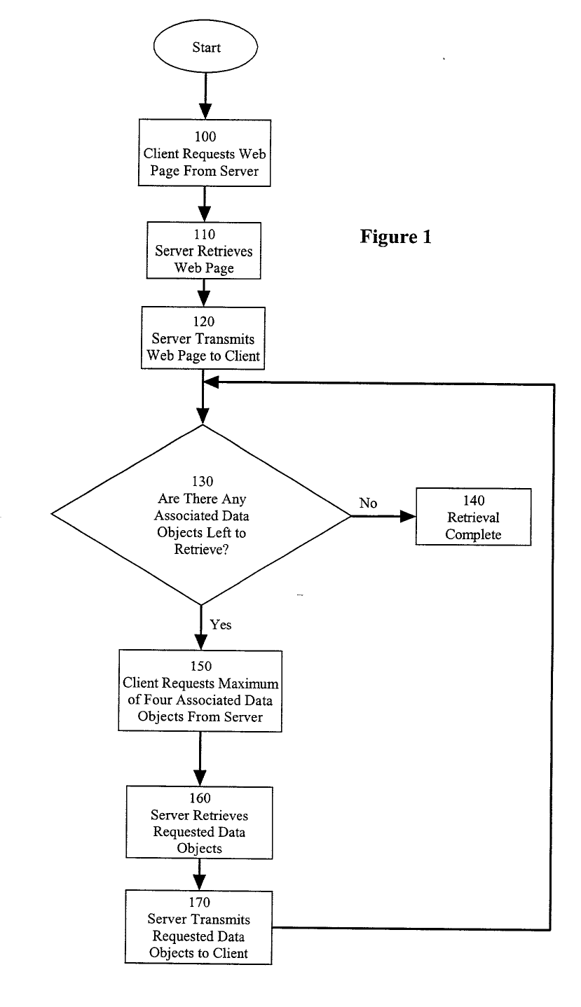

FIG. 2A is a block diagram of a client/server architecture in accordance with one embodiment of the present invention.

FIG. 2B is a block diagram of a client/server request servicing architecture in accordance with one embodiment of the present invention.

FIG. 2C is a block diagram of the client of FIG. 2B in greater detail in accordance with one embodiment of the present invention.

FIG. 2D is a block diagram of the server of FIG. 2B in greater detail in accordance with one embodiment of the present invention.

FIG. 3 is a flow diagram of the process of retrieving a data item and available associated data items in accordance with one embodiment of the present invention.

FIG. 4 is a flow diagram of the process of requesting associated data items in accordance with one embodiment of the present invention.

FIG. 5 is a flow diagram of the process of requesting associated data items in accordance with one embodiment of the present invention.

FIG. 6 is a flow diagram of the process of retrieving a web page via a wireless network in accordance with one embodiment of the present invention.

FIG. 7 is a flow diagram of the process of transmitting to a client new/unchanged indicators for associated objects in accordance with one embodiment of the present invention.

FIG. 8 is a flow diagram of the process of retrieving an object in accordance with one embodiment of the present invention.

### DETAILED DESCRIPTION OF THE INVENTION

The invention is a method and apparatus for compound request processing. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

Retrieving Previously Retrieved Data Items

In one embodiment of the present invention, a server maintains a cache of data items it has provided to a client. The client also maintains a cache of data items. When the client requests a data item from the server, the server retrieves the data item. In one embodiment, the server also retrieves all available associated data items. If the data items were previously requested, the server determines which associated data items are unchanged. Then, the server transmits the data item along with information indicating whether associated data items are unchanged to the client without converting the response to another transmission protocol.

Since the information indicating whether a data item is unchanged is typically much smaller than the data item, a significantly lower amount of data is transmitted between the server and the client with the above embodiment. In systems where transmissions between clients and servers are expensive (e.g., wireless networks), the above embodiment reduces the total cost of some transmissions.

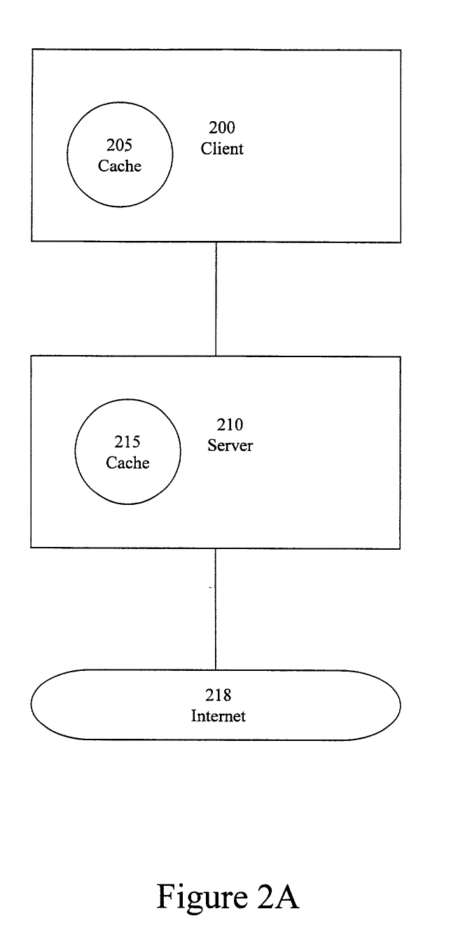

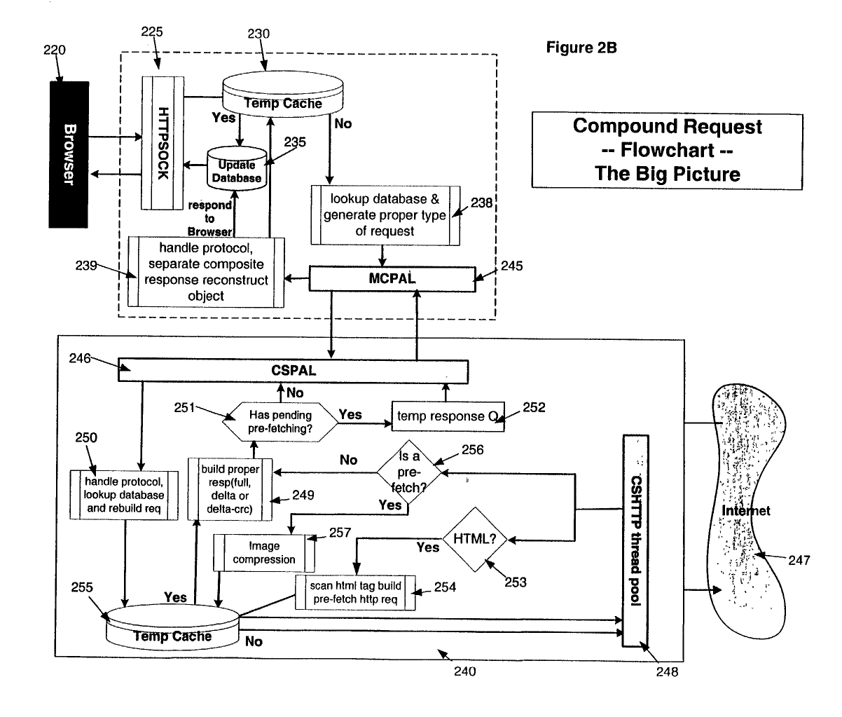

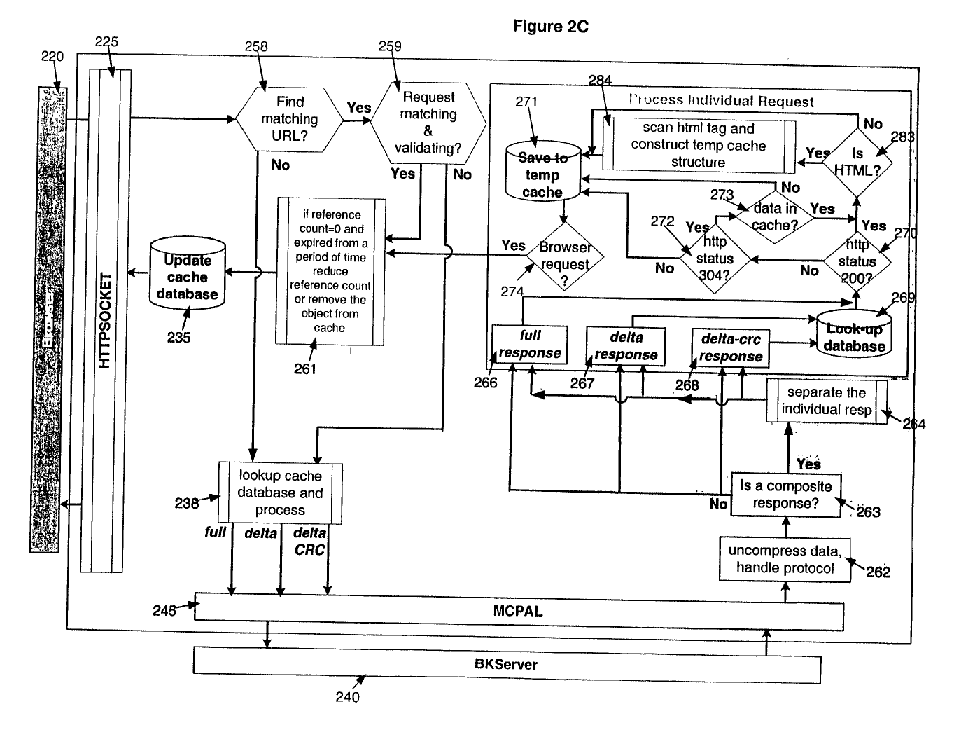

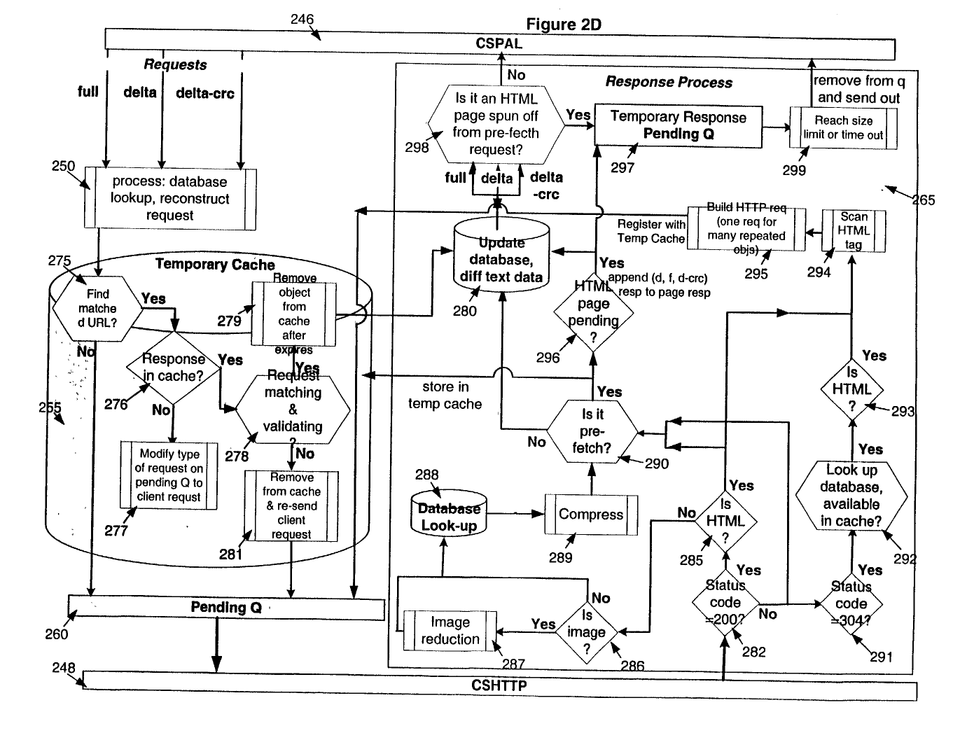

FIG. 2A illustrates a client/server architecture in accordance with one embodiment of the present invention. The client 200 includes a cache 205 and connects to the server 210. The server has a cache 215 of data items it previously sent to the client. The server is also connected to the Internet 218.

FIG. 2B illustrates a client/server request servicing architecture in accordance with one embodiment of the present invention. When a request is initiated by the browser 220, a socket 225 is opened and the request is sent through the socket. After the client receives the request, the client temp cache 230 is checked to see if a response for the request already exists. If it does, the database 235 is updated and the response object is sent back to the browser and displayed. If the response object is not in the temp cache, a database lookup is performed and a request is prepared 238 for submittal to the server 240. The request type is identified, and it is then compressed and sent to the server side of the process via the Protocol Application Layer 245. A response from the server is processed via the Protocol Application Layer. Response objects are reconstructed by separating composite responses 239. The database is updated and the response is sent to the browser.

On the server, the request from the client is processed via the server's Protocol Application Layer 246. When the request type has been identified the process begins a cache database lookup and reconstructs the request 250. If the requested item is not in the temp cache 255, the request is sent to the Internet 247 through a CSHTTP thread pool 248. The response from the internet returns through the CSHTTP thread pool. If the response is HTML 253, the html tag is scanned and a pre-fetch http request is built 254. The pre-fetch request is registered in the temp cache, and sent to the Internet through the CSHTTP thread pool. If the response is a pre-fetch 256, the image is compressed 257 and the data is added to the temp cache. If the response is not a pre-fetch, a proper response is built 249.

If the requested item is in the temp cache, a proper response is built. If this response does not have some associated pending pre-fetch 251, the response is sent to the client via the server's Protocol Application Layer. If the response has some associated pending pre-fetch, it is added to a temp response Q 252, which is sent to the client through the server's Protocol Application Layer later.

Client

FIG. 2C illustrates the client of FIG. 2B in greater detail in accordance with one embodiment of the present invention. When a request is initiated by the browser 220, a socket 225 is opened and the request is sent through the socket. After the client receives the request, the client temp cache is checked to see if it contains a matching URL 258. If it does, it is determined whether the requested data is valid 259. If the data is valid, the object may be removed from the cache if the reference count is 0 and a time period is expired 261. Then, the database 235 is updated and the response object is sent back to the browser and displayed. If the response object is not in the temp cache or if the requested data is not valid, a database lookup is performed and a request is prepared 238 for submittal to the server 240. The request type is identified, and it is then compressed and sent to the server side of the process via the Protocol Application Layer 245.

A response from the server is processed via the Protocol Application Layer. The response is uncompressed 262. It is determined whether the response is a composite response 263. If it is a composite response, the response is separated into individual responses 264. For each individual response, it is determined whether it is a full response 266, a delta response 267 or a delta-crc response 268. If the response is a delta or delta-crc response, a lookup is performed in the database 269. It is determined whether the response is http status 200 270. If it is, it is determined whether the response is HTML 283. If the response is HTML, the html tag is scanned and a pre-fetch http request is built 284. Regardless of whether the response is HTML, it is saved in the temp cache 271.

If the response is not http status 200, it is determined whether it is http status 304 272. If it is, it is determined whether the data is in the cache 273. If the data is not in the temp cache, it is saved to the temp cache. If it is in the temp cache, it is determined whether the response is HTML 283. After the response is saved to the cache, if there is a browser request 274, the object may be removed from the cache if the reference count is 0 and a time period is expired 261.

Server

FIG. 2D illustrates the server of FIG. 2B in greater detail in accordance with one embodiment of the present invention. When the request type has been identified the process begins a cache database lookup and reconstructs the request 250. It is determined whether a matching URL is found 275 in the temp cache 255. If no matching URL is found, the request is sent to the pending Q 260 for transfer to the Internet via the CSHTTP thread pool 248. If there is a matching URL, it is determined whether the response is in the cache 276. If the response is not in the cache, the type of request on the pending queue is modified to match the client request 277. If the response is in the cache, it is determined whether the requested data is valid 278. If it is, the object is removed from the cache after it expires 279 and the database is updated 280. If the requested data is not valid, it is removed form the cache and the client request is re-sent 281 and put on the pending Q.

When a reply comes back from the Internet, it passes through the CSHTTP thread pool and it is determined whether the status code is 200 282. If it is, it is determined whether the response is HTML 285. If the response is not HMTL, it is determined whether it is an image 286. If it is an image, image reduction is performed 287. Regardless of whether it is an image, a database lookup is performed 288 and the data is compressed 289. If the status code is not 200, it is determined whether the status code is 304 291. If it is, a database lookup is performed to determine whether the response is available in the cache 292. If it is, it is determined whether the response is HTML 293. If the response is HTML in 293 or 285, the HTML tag is scanned 294. Then, an http request is built 295 and sent to the pending Q.

For all requests, it is determined whether the response is to a pre-fetch 290. If it is not, the database is updated 280. If it is, it is added to the pending Q and it is determined whether an HTML page is pending 296. If an HTML page is pending, the data base is updated and the response is added to the temporary response pending Q 297. After a database update, it is determined whether the response is an HTML page spun off from a pre-fetch request 298. If it is not, the response is sent to the client through the Protocol Application Layer 246. If the response is an HTML page spun off from a pre-fetch request, it is added to the temporary response pending Q. Once the response on the temporary response pending Q reaches a size limit or a time out 299, it is removed from the Q and sent to the client through the Protocol Application Layer. Thus, the server will piggyback all “no change” responses back to the client within the single reply.

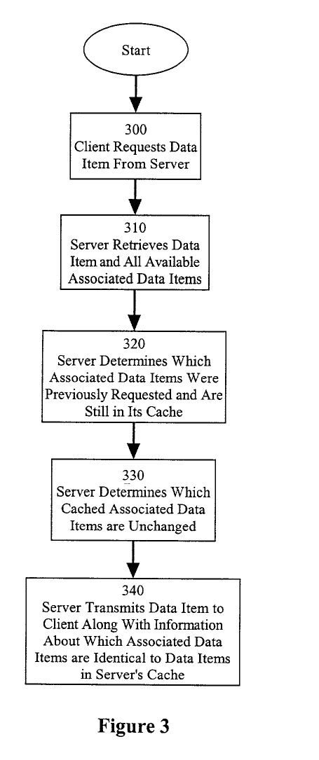

FIG. 3 illustrates the process of retrieving a data item and available associated data items in accordance with one embodiment of the present invention. At step 300, a client requests a data item from a server. At step 310, the server retrieves the data item and all available associated data items. In one embodiment, the server retrieves the data item and available associated data items from the Internet. At step 320, the server determines which associated data items were previously requested and are still in its cache. At step 330, the server determines which cached associated data items are unchanged. At step 340, the server transmits the data item to the client along with information about which associated data items are identical to data items in the server's cache. In one embodiment, the server updates its cache with the retrieved data items.

In one embodiment, when a client wishes to request an associated data item, it first determines whether the server indicated that the associated data item is unchanged. If the associated data item is unchanged, the client uses the copy of the associated data item in the client's cache. If the associated data item is changed, the client requests the associated data item from the server.

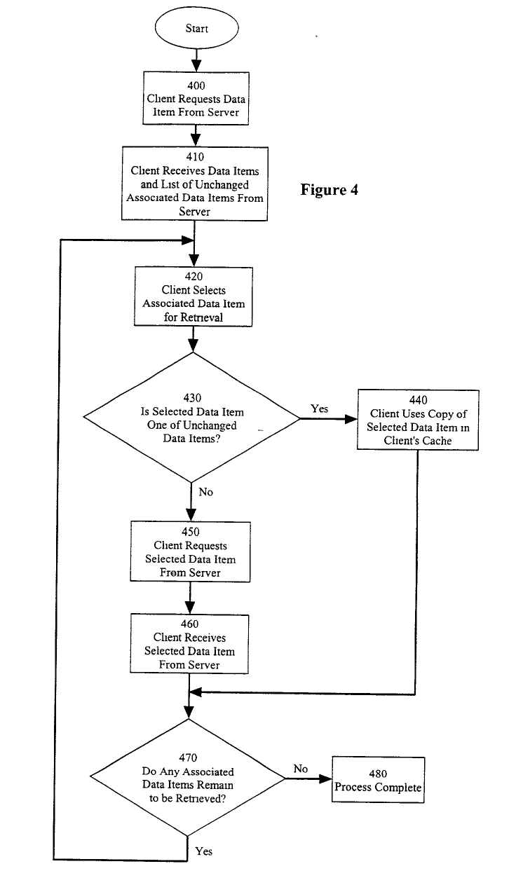

FIG. 4 illustrates the process of requesting associated data items in accordance with one embodiment of the present invention. At step 400, a client requests a data item from a server. At step 410, the client receives the data items and a list of unchanged associated data items from the server. In one example, the data item is a web page and the associated data items are elements (e.g., images, sound files, etc.) of the web page. At step 420, the client selects an associated data item for retrieval. The selection could be made manually by a user, or it could be an automatic selection. For example, a web browser may request a web page and then automatically request all elements of the page, such as images or audio files, without further request from a user.

At step 430, it is determined whether the selected data item is one of the unchanged data items. If the selected data item is one of the unchanged data items, at step 440, the client uses the copy of the selected data item in the client's cache and the process continues at step 470. If the selected data item is not one of the unchanged data items, at step 450, the client requests the selected data item from the server. At step 460, the client receives the selected data item from the server and the process continues at step 470.

At step 470, it is determined whether any associated data items remain to be retrieved. If an associated data item remains to be retrieved, the process repeats at step 420. If no associated data items remain to be retrieved, at step 480, the process is complete.

Requesting More Than Four Data Items at One Time

In one embodiment, the client can request an unlimited number of associated data items from the server with one request. In one embodiment, the client accumulates data item requests until a specific number of requests are pending. Then, the client sends all pending requests as one request. In another embodiment, the client accumulates data item requests until a period of time passes. Then, the client sends all pending requests as one request. In another embodiment, a time period passing or a threshold number of pending requests causes all pending requests to be sent to the server as one request. The server retrieves the associated data items and stores them in a cache. Then, the server transmits as many data items to the client as the client requests. In one embodiment, the server retrieves the associated data items no more than four at a time.

Since there is a latency period associated with each request, the above embodiment decreases the total amount of time required for data transfers by reducing the number of requests. If the latency period is high (e.g., wireless networks for cell phones or pagers), the above embodiment decreases total transmission time noticeably.

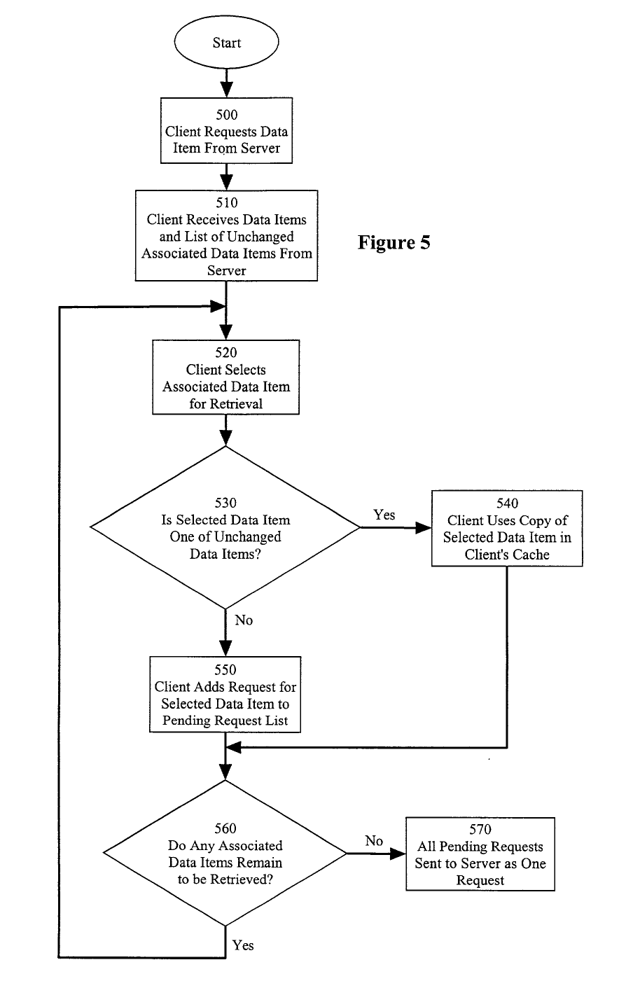

FIG. 5 illustrates the process of requesting associated data items in accordance with one embodiment of the present invention. At step 500, a client requests a data item from a server. At step 510, the client receives the data items and a list of unchanged associated data items from the server. At step 520, the client selects an associated data item for retrieval.

At step 530, it is determined whether the selected data item is one of the unchanged data items. If the selected data item is one of the unchanged data items, at step 540, the client uses the copy of the selected data item in the client's cache and the process continues at step 560. If the selected data item is not one of the unchanged data items, at step 550, the client adds a request for the selected data item to a pending request list and the process continues at step 560.

At step 560, it is determined whether any associated data items remain to be retrieved that are not already on the pending request list. If an associated data item remains to be retrieved and the associated data item is not already on the pending request list, the process repeats at step 520. If all associated data items are retrieved or are already on the pending request list, at step 570, all pending requests are sent to the server as one request.

Web Page Retrieval Via Wireless Networks

In one embodiment, the connection between the client and the server is a wireless network. In one embodiment, data items are web pages and associated objects.

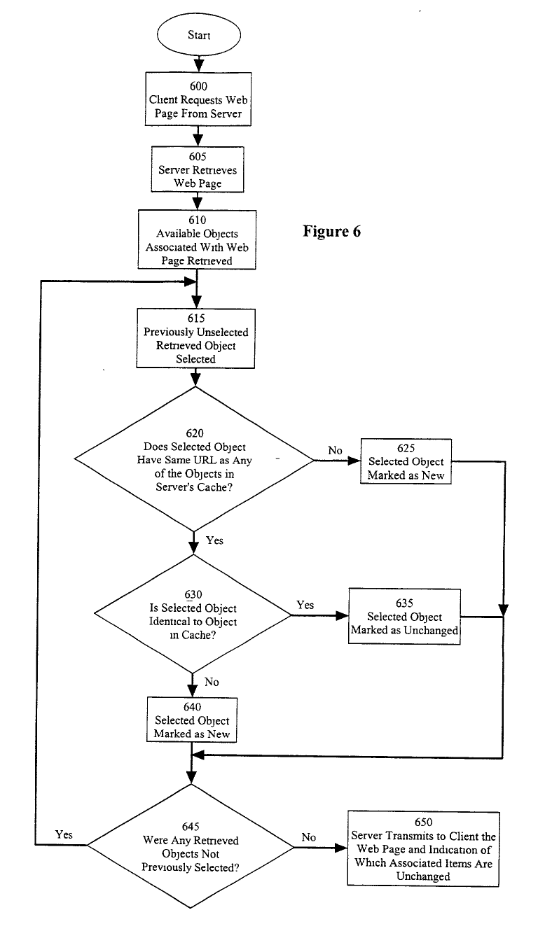

FIG. 6 illustrates the process of retrieving a web page via a wireless network in accordance with one embodiment of the present invention. At step 600, a client requests a web page from a server. In this embodiment, the client sends a uniform resource locator (URL) to indicate which web page is desired. In another embodiment, a handle to a URL (HURL) is sent in place of the URL. The HURL is associated with the URL at the server and is typically much smaller than a URL. At step 605, the server retrieves the web page. At step 610, the available objects associated with the web page (e.g., images or frames) are retrieved by the server. At step 615, a previously unselected retrieved object is selected. At step 620, it is determined whether the selected object has the same URL as any of the objects in the server's cache. If the selected object does not have the same URL as any of the objects in the server's cache, at step 625 the selected object is marked as new and the process continues at step 645.

If at step 620 the selected object has the same URL as one of the objects in the server's cache, at step 630, it is determined whether the selected object is identical to the object in the cache. If the selected object is identical to the object in the cache, at step 635, the selected object is marked as unchanged and the process continues at step 645. If the selected object is not identical to the object in the cache, at step 640, the selected object is marked as new and the process continues at step 645.

At step 645, it is determined whether any retrieved objects were not previously selected. If a retrieved object was previously not selected, the process repeats at step 615. If all retrieved objects were previously selected, at step 650, the server transmits to the client the web page and an indication of which associated items are unchanged. In one embodiment, the indication is a bitmap with one bit representing whether an associated object is new or unchanged. In another embodiment, the indication is a list of URLs for the unchanged objects. In another embodiment, the indication is a list of HURLS for unchanged objects.

Transmitting New/Unchanged Indicators Over Multiple Transmissions

In one embodiment, not all associated objects are retrievable by the server before a web page is sent to the client. In this embodiment, the web page is transmitted to the client with new/unchanged indicators for all associated objects which are retrieved by the server before the web page is sent. New/unchanged indicators for associated objects which are retrieved by the server after the web page is sent are transmitted to the client in subsequent transmissions if appropriate.

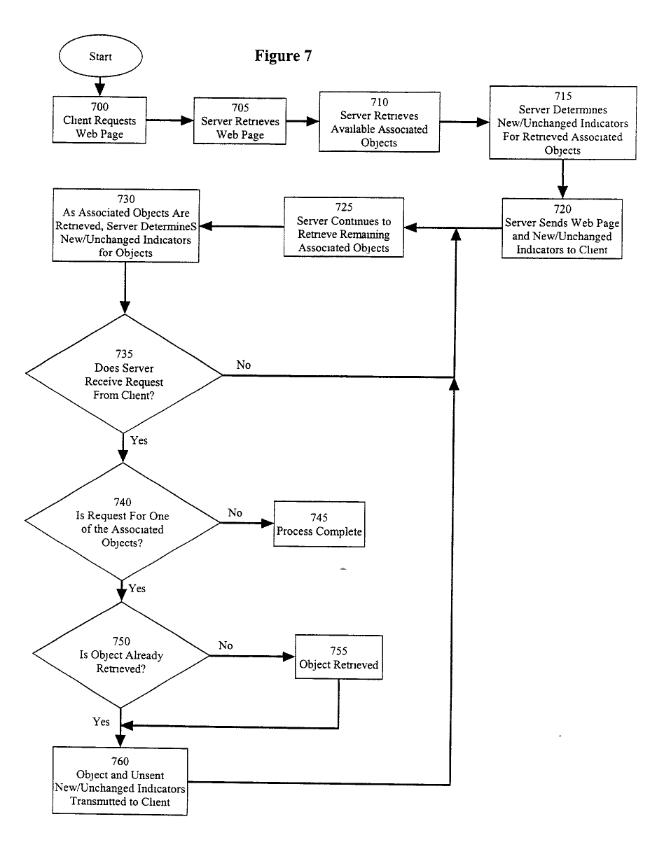

FIG. 7 illustrates the process of transmitting to a client new/unchanged indicators for associated objects in accordance with one embodiment of the present invention. At step 700, a client requests a web page. At step 705, the server retrieves the web page. At step 710, the server retrieves available associated objects. At step 715, the server determines new/unchanged indicators for all retrieved associated objects. At step 720, the server sends the web page and new/unchanged indicators to the client. At step 725, the server continues to retrieve the remaining associated objects. At step 730, as associated objects are retrieved, the server determines new/unchanged indicators for the objects.

At step 735, it is determined whether the server receives a request from the client. If the server does not receive a request from the client, the process continues at step 725. If the server receives a request from the client, at step 740, it is determined whether the request is for one of the associated objects. If the request is not for one of the associated objects, at step 745, the process is complete and the server starts a new process for the request at step 700. If the request is for one of the associated objects, at step 750, it is determined whether the object is already retrieved. If the object is not already retrieved, at step 755, the object is retrieved and the process continues at step 760. If the object is already retrieved, at step 760 the object and unsent new/unchanged indicators are transmitted to the client and the process repeats at step 725.

New/Unchanged Determination When Object Not In Server Cache

In one embodiment, the client maintains a cache of previously retrieved objects and computes a value using an error correction method (e.g., a cyclic redundancy code) from an object the client is requesting again. The value is transmitted to the server along with the request. After the server retrieves the object, if the server does not have the object in its cache, the server computes a second value using the same error correction method as the client from the retrieved object. If the value from the client and the second value are identical, the server marks the object as unchanged. If the values are not identical, the server marks the object as new.

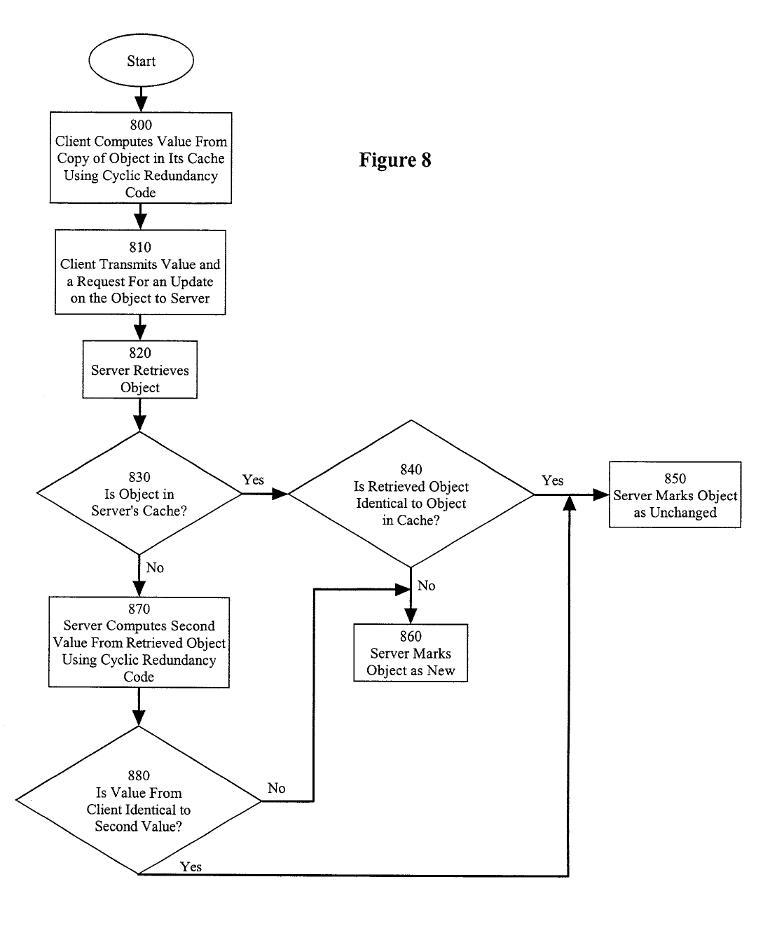

FIG. 8 illustrates the process of retrieving an object in accordance with one embodiment of the present invention. At step 800, the client computes a value from a copy of an object in its cache using a cyclic redundancy code. At step 810, the client transmits the value and a request for an update on the object to the server. At step 820, the server retrieves the object. At step 830, it is determined whether the object is in the server's cache. If the object is in the server's cache, at step 840, it is determined whether the retrieved object is identical to the object in the cache. If the retrieved object is identical to the object in the cache, at step 850, the server marks the object as unchanged. If the retrieved object is not identical to the object in the cache, at step 860, the server marks the object as new.

If at step 830, the object is not in the server's cache, at step 870, the server computes a second value from the retrieved object using the cyclic redundancy code. At step 880, it is determined whether the value from the client is identical to the second value. If the value from the client is identical to the second value, the process continues at step 850. If the value from the client is not identical to the second value, the process continues at step 860.

Thus, a method and apparatus for compound request processing is described in conjunction with one or more specific embodiments. The invention is defined by the following claims and their full scope and equivalents.

1. A method for retrieving a data item comprising:
transmitting a request for said data item from a client to a server;
retrieving said data item by said server;
retrieving one or more associated data items by said server;
obtaining an indicator corresponding to each of said associated data items; and
transmitting said data item and said indicators from said server to said client.

2. The method of claim 1 wherein said indicators show whether said associated data items have changed.

3. The method of claim 2 wherein said step of obtaining comprises:
maintaining a first cache of a plurality of previously requested data objects on said client;
maintaining a second cache of said plurality of previously requested data objects on said server; and
indicating a first associated data item is unchanged if said first associated data item is identical to a first previously requested version of said first associated data item in said second cache.

4. The method of claim 3 further comprising:
using a second previously requested version of said first associated data item in said first cache if said first indicator indicates that said first associated data item is unchanged.

5. The method of claim 1 further comprising:
transmitting a second request for five or more of said associated data items from said client to said server.

6. The method of claim 1 wherein said client and said server are connected by a wireless network.

7. The method of claim 1 further comprising:
transmitting a second request for a second associated data item from said client to said server;
retrieving said second associated data item by said server; and
determining a second indicator for a second associated data item.

8. The method of claim 7 wherein said step of transmitting said second request comprises:
maintaining a first cache of a plurality of previously requested data objects on said client;
calculating a value from a copy of said data item using a correction method wherein said copy is in said first cache; and
transmitting said value from said client to said server.

9. The method of claim 8 wherein said correction method is a cyclic redundancy code.

10. The method of claim 8 wherein said step of determining said second indicator comprises:
calculating a second value from said second associated data item using said correction method; and
indicating said second associated data item is unchanged if said value is identical to said second value.

11. The method of claim 1 wherein said data item is a web page.

12. The method of claim 1 further comprising:
retrieving a second associated data item after said step of transmitting said data item.

13. The method of claim 12 further comprising:
determining a second indicator for said second associated data item; and
transmitting said second indicator from said server to said client.

14. A data retrieval system comprising:
a first transmission unit configured to transmit a request for a data item from a client to a server;
a first retrieval unit configured to retrieve said data item by said server;
a second retrieval unit configured to retrieve one or more associated data items by said server;
a obtaining unit configured to obtain an indicator corresponding to each of said associated data items; and
a second transmission unit configured to transmit said data item and said indicators from said server to said client.

15. The data retrieval system of claim 14 wherein said indicators show whether said associated data items have changed.

16. The data retrieval system of claim 15 wherein said obtaining unit comprises:
a first maintenance unit configured to maintain a first cache of a plurality of previously requested data objects on said client;
a second maintenance unit configured to maintain a second cache of said plurality of previously requested data objects on said server; and
an indication unit configured to indicate a first associated data item is unchanged if said first associated data item is identical to a first previously requested version of said first associated data item in said second cache.

17. The data retrieval system of claim 16 further comprising:
a selection unit configured to select a second previously requested version of said first associated data item in said first cache if said first indicator indicates that said first associated data item is unchanged.

18. The data retrieval system of claim 14 further comprising:
a third transmission unit configured to transmit a second request for five or more of said associated data items from said client to said server.

19. The data retrieval system of claim 14 wherein said client and said server are connected by a wireless network.

20. The data retrieval system of claim 14 further comprising:
a third transmission unit configured to transmit a second request for a second associated data item from said client to said server;
a third retrieval unit configured to retrieve said second associated data item by said server; and
a second determiner configured to determine a second indicator for a second associated data item.

21. The data retrieval system of claim 20 wherein said third transmission unit comprises:
a maintenance unit configured to maintain a first cache of a plurality of previously requested data objects on said client;
a calculation unit configured to calculate a value from a copy of said data item using a correction method wherein said copy is in said first cache; and
a fourth transmission unit configured to transmit said value from said client to said server.

22. The data retrieval system of claim 21 wherein said correction method is a cyclic redundancy code.

23. The data retrieval system of claim 21 wherein said second determiner comprises:
a second calculation unit configured to calculate a second value from said second associated data item using said correction method; and
an indication unit configured to indicate said second associated data item is unchanged if said value is identical to said second value.

24. The data retrieval system of claim 14 wherein said data item is a web page.

25. The data retrieval system of claim 14 further comprising:
a third retrieval unit configured to retrieve a second associated data item after said step of transmitting said data item.

26. The data retrieval system of claim 24 further comprising:
a second determiner configured to determine a second indicator for said second associated data item; and
a third transmission unit configured to transmit said second indicator from said server to said client.

27. A computer program product comprising:
a computer usable medium having computer readable program code embodied therein configured to retrieve a data item, said computer program product comprising:
computer readable code configured to cause a computer to transmit a request for said data item from a client to a server;
computer readable code configured to cause a computer to retrieve said data item by said server;
computer readable code configured to cause a computer to retrieve one or more associated data items by said server;
computer readable code configured to cause a computer to obtain an indicator corresponding to each of said associated data items; and
computer readable code configured to cause a computer to transmit said data item and said indicators from said server to said client.

28. The computer program product of claim 27 wherein said indicators show whether said associated data items have changed.

29. The computer program product of claim 28 wherein said computer readable code configured to cause a computer to determine comprises:
computer readable code configured to cause a computer to maintain a first cache of a plurality of previously requested data objects on said client;
computer readable code configured to cause a computer to maintain a second cache of said plurality of previously requested data objects on said server; and
computer readable code configured to cause a computer to indicate a first associated data item is unchanged if said first associated data item is identical to a first previously requested version of said first associated data item in said second cache.

30. The computer program product of claim 29 further comprising:
computer readable code configured to cause a computer to select a second previously requested version of said first associated data item in said first cache if said first indicator indicates that said first associated data item is unchanged.

31. The computer program product of claim 27 further comprising:
computer readable code configured to cause a computer to transmit a second request for five or more of said associated data items from said client to said server.

32. The computer program product of claim 27 wherein said client and said server are connected by a wireless network.

33. The computer program product of claim 27 further comprising:
computer readable code configured to cause a computer to transmit a second request for a second associated data item from said client to said server;
computer readable code configured to cause a computer to retrieve said second associated data item by said server; and
computer readable code configured to cause a computer to determine a second indicator for a second associated data item.

34. The computer program product of claim 33 wherein said computer readable code configured to cause a computer to transmit said second request comprises:
computer readable code configured to cause a computer to maintain a first cache of a plurality of previously requested data objects on said client;
computer readable code configured to cause a computer to calculate a value from a copy of said data item using a correction method wherein said copy is in said first cache; and
computer readable code configured to cause a computer to transmit said value from said client to said server.

35. The computer program product of claim 34 wherein said correction method is a cyclic redundancy code.

36. The computer program product of claim 34 wherein said computer readable code configured to cause a computer to determine said second indicator comprises:
computer readable code configured to cause a computer to calculate a second value from said second associated data item using said correction method; and
computer readable code configured to cause a computer to indicate said second associated data item is unchanged if said value is identical to said second value.

37. The computer program product of claim 27 wherein said data item is a web page.

38. The computer program product of claim 27 further comprising:
computer readable code configured to cause a computer to retrieve a second associated data item after said step of transmitting said data item.

39. The computer program product of claim 38 further comprising:
computer readable code configured to cause a computer to determine a second indicator for said second associated data item; and
computer readable code configured to cause a computer to transmit said second indicator from said server to said client.
